(19) United States
(12) Patent Application Publication
(10) Pub. No.: US 2013/0270021 A1
(43) Pub. Date: Oct. 17, 2013

(54) Electric-Drive Motorcycle

(71) Applicant: FIBRES S.R.O., OSTRAVA-VITKOVICE (CZ)

(72) Inventors: Michal Kubanek, Ostrava-Vitkovice (CZ); Stanislav Leffner, Ostrava-Vitkovie (CZ)

(73) Assignee: FIBRES S.R.O., Ostrava-Vitkovice (CZ)

(21) Appl. No.: 13/633,003

(22) Filed: Oct. 1, 2012

(30) Foreign Application Priority Data
Jan. 16, 2012 (CZ) 2012-25486
Jan. 16, 2012 (EP) RCD001976366
Feb. 28, 2012 (EP) 12466003.6

(51) Int. Cl. B62K 11/00; H02K 7/108

(52) U.S. Cl. CPC B62K 11/00; H02K 7/108
USPC 180/220; 310/52

(57) ABSTRACT

Embodiments discussed herein relate to, among other things, an electric-drive motorcycle in which one or more batteries are mounted along with a motor in a supporting frame to minimize the space required. Also discussed herein are example electric drives for vehicles, such as motorcycles, that comprise an alternating-current electric motor and a centrifugal clutch, among other things.

### CROSS-REFERENCE TO RELATED APPLICATIONS

This application claims priority to and the benefit of European Patent Application No. 12466003.6, filed Feb. 28, 2012, Czech Republic Utility Model Application No. 2012-25486, filed Jan. 17, 2012, European Patent Application No. RCD 001976366, filed Jan. 16, 2012, and Czech Republic Patent Application No. 2011-618, filed Oct. 3, 2011.

### FIELD

Embodiments of the invention relate, generally, to electric-drive vehicles, such as electric-drive motorcycles.

### BACKGROUND

Motorcycles and other types of vehicles are commonly used for transportation, recreation and various other activities by people of all ages. Dirt biking, for example, is an outdoor activity enjoyed by many outdoor enthusiasts and adventure seekers.

More recently, automobiles and other types of vehicles have begun supplementing or even replacing combustion engines and the related drive systems with electric drive systems. In this regard, areas for improving the configuration of electric drive systems have been identified. Through applied effort, ingenuity, and innovation, solutions to improve such systems have been realized and are described herein in connection with some embodiments of the present invention.

### BRIEF SUMMARY

Systems and related methods are provided to, in general, electric motorcycles and the frames that couple together the components of electric motorcycles. In this regard, embodiments discussed herein may include an electric motorcycle driving unit that, when mounted to the motorcycle's frame, has a shorter side of the base of one or more batteries being positioned cross-wise to the direction of driving. The electric drive can contain, for example, an AC electric engine, a centrifugal clutch and a case, where the AC electric engine is mounted in the case and the centrifugal clutch is linked to the shaft of the AC electric engine. In some embodiments, a stator of the AC electric engine can be in contact with the case and is advantageously linked to the bottom of the case. According to some embodiments, the case is linked from the side opposite to the centrifugal clutch with the basket of the centrifugal clutch and is produced from aluminum alloy. It is also advantageous in some embodiments, that at least two batteries are located in at least two layers, one above the other, and the batteries be lead, lithium and/or any other suitable material. Further, in some embodiments, the length of the frame can be no more than 700 mm. One advantage of placing the batteries in the frame according to some embodiments discussed herein is that the capacity of the batteries can be increased in a child's or other electric motorcycle while the width of the driving unit can be kept to the usual proportions of an adult combustion motorcycle. An advantage of using an AC electric drive is that it is lighter and smaller with the same output despite the fact that in addition to the AC electric engine it also contains a centrifugal clutch and cooling case to prevent overheating. The AC electric engine can be located in the frame together with the batteries without decreasing battery capacity while keeping the width of the driving unit the same as the usual proportions of an adult combustion engine motorcycle. The driving unit as a whole can be lighter and simpler to construct than currently used driving units and gives sufficient output for a non-adult electric motorcycle while retaining the proportions of an adult motorcycle.

For example, some embodiments may include a motorcycle frame comprising: an electric drive assembly comprising an alternating current electric motor and centrifugal clutch; and at least one narrow energy storage device configured to store power used by the electric drive assembly. The motorcycle frame can be configured to accommodate an electric motorcycle that has a seat top 700 millimeters or less from where the electric motorcycle's rear wheel touches the ground.

In some embodiments, the electric drive assembly further comprises a shaft connected to the electric motor, a stator, and a housing unit configured to enclose and provide protection and cooling to the alternating electric motor and the centrifugal clutch, among other things. The housing can be attached to the stator by a bracket, for example. The housing unit can be configured to connect to the centrifugal clutch opposite the positioning of the alternating current electric motor within the housing unit. The housing unit can be configured to protect the alternating current electric motor and aid in dissipating heat generated by the alternating current electric motor during operation.

The narrow energy storage device can include a plurality of batteries and/or a battery cells. The batteries and/or individual battery cells can be electrically and/or mechanically coupled together. The narrow energy storage device can also include a housing that encloses the plurality of batteries and/or other components thereof.

In accordance with some embodiments, the motorcycle can comprise a frame configured to mount to a front wheel and a rear wheel, the frame defining a longitudinal axis, a vertical axis and a lateral axis. The longitudinal axis can extend in a direction from the front wheel to the rear wheel when mounted. The vertical axis can extend in the direction of gravity. The lateral axis can extend orthogonal to a plane defined by the longitudinal axis and the vertical axis.

The motorcycle can also include at least one electric motor configured to be mounted in the frame, and a battery pack also configured to be mounted in the frame. The battery pack can define a length, a width and a height, wherein the length is larger than both the width and the height, and the length extends in a direction parallel to the longitudinal axis of the frame when mounted in the frame. Each battery pack can include a housing that encloses the plurality of batteries, which themselves each include a respective battery housing. The battery packs of the motorcycle can be stacked to form layers along the longitudinal axis, the vertical axis, and/or the lateral axis of the motorcycle (the axes are discussed further below).

The motor can be mounted in proximity to where a rear fork extends for mounting the rear wheel. In other embodiments, one or more electric motors may be mounted further from the frame, such as where the rear fork connects to the rear wheel and/or any other suitable location.

The motorcycle can also include a seat on top of which a user may sit, which can be mounted to the frame. In some embodiments, such as motorcycles designed for children, the top of the seat can 700 millimeters or less from where the rear wheel touches the ground when the rear wheel is mounted to the frame.

In accordance with some embodiments, an electric motor assembly can be included that comprises: an alternating current electric motor; a shaft connected to the electric motor; a centrifugal clutch; a stator; and a housing unit configured to enclose and provide protection and cooling to the alternating electric motor and the centrifugal clutch, wherein the housing is attached to the stator by a bracket.

The housing unit can be configured to connect to the centrifugal clutch opposite the positioning of the alternating current electric motor within the housing unit. The housing unit can also or instead be configured to protect the alternating current electric motor and aid in dissipating heat generated by the alternating current electric motor during operation. For example, the housing unit can comprise an aluminum alloy.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 shows an example electric motorcycle in accordance with some embodiments discussed herein;

FIG. 2 shows a side view of the frame, battery packs and motor of the example electric motorcycle from FIG. 1 in accordance with some embodiments discussed herein;

FIG. 3 shows a rear-top perspective view of the components shown in FIG. 2;

FIG. 4 shows an example arrangement of battery packs in accordance with some embodiments discussed herein;

FIG. 5 shows an example overall view of an electric drive in accordance with some embodiments discussed herein;

FIG. 6 shows a cutaway view of the electric drive of FIG. 5;

FIG. 7 shows a rear view of the electric drive of FIG. 5; and

FIG. 8 shows a front view of the electric drive of FIG. 5.

### DETAILED DESCRIPTION

Embodiments of the present invention now will be described more fully hereinafter with reference to the accompanying drawings, in which some, but not all embodiments of the inventions are shown. Indeed, embodiments of the invention may be embodied in many different forms and should not be construed as limited to the embodiments set forth herein; rather, these embodiments are provided so that this disclosure will satisfy applicable legal requirements Like numbers refer to like elements throughout.

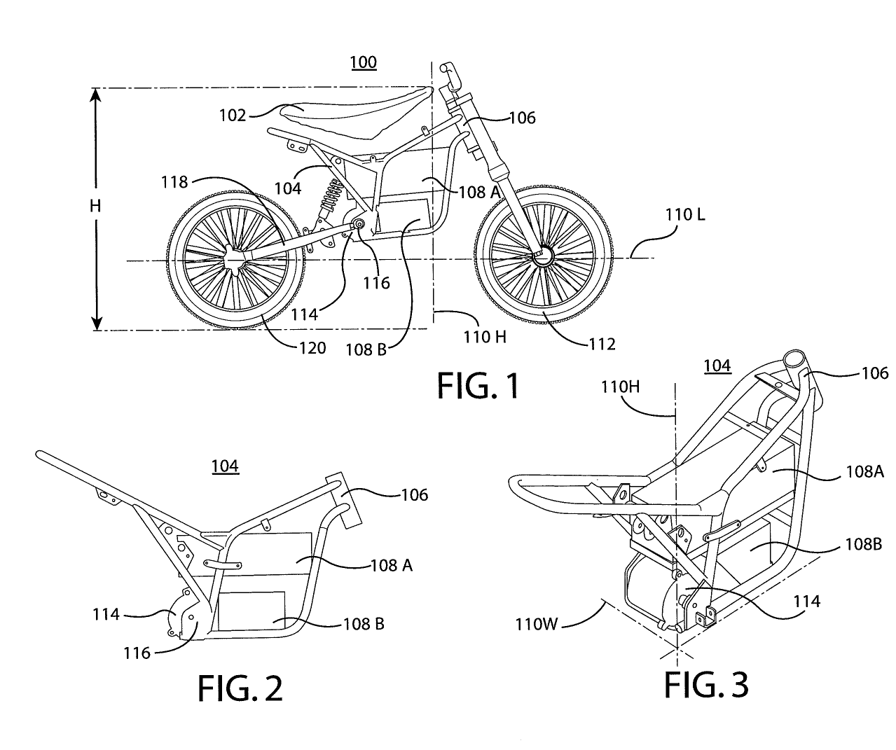

FIG. 1 shows an example electric motorcycle, namely motorcycle 100, which may be in accordance with some embodiments discussed herein. Motorcycle 100 may include one or more batteries that provide energy to drive it. The batteries may be located in any suitable location and arranged in any suitable manner. For example, the batteries can be mounted either under the seat 102 above frame 104, and/or in frame 104.

In some embodiments, such as those where the top of motorcycle seat 102 is up to 700 mm above the ground (without the suspension system, if applicable, of the motorcycle compressed), one or more batteries can be arranged in packs that are rectangular in shape. The battery packs 108A and 108B can be mounted in frame 104 so that the longer side of each battery pack is in the transverse direction relative to the longitudinal axis of the motorcycle. For example, as shown in FIGS. 1, 2 and 3, the batteries 108A and 108B can be stacked together such that the longer side of battery packs 108A and/or 108B extend parallel to a longitudinal axis, shown as longitudinal axis 110L, that runs along the length of the frame in a direction from steering column 104, where front wheel 112 is mounted, to rear wheel 120 (when mounted as shown in FIG. 1). Also shown in the drawings are two other axes defined by frame 104, namely vertical axis 110W that extends parallel to the width of frame 104, and lateral axis 110H that extends in the direction of gravity and parallel to the height of frame 104. Each of longitudinal axis 110L, vertical axis 110W and lateral axis 110H extends in a direction orthogonal to a plane defined by the other two axes.

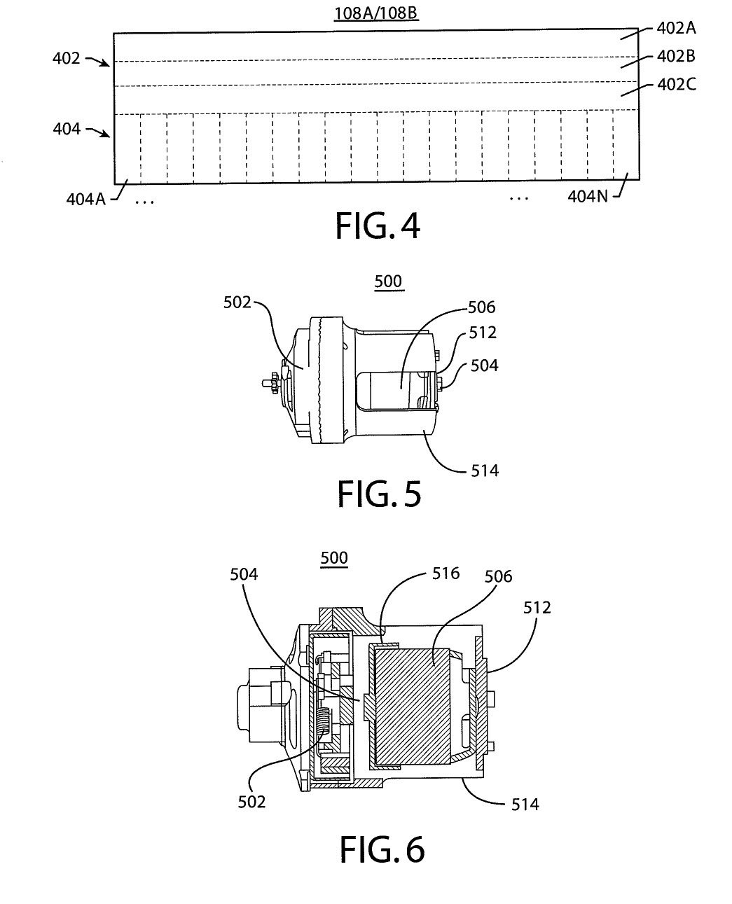

In some embodiments, battery packs 108A and/or 108B can include any type of suitable battery. For example, each of battery packs 108A and/or 108B can comprise at least one 12V lead-acid battery and/or lithium battery in any suitable shape. Battery packs 108A and/or 108B can be configured to hold any suitable amount of power. For example, and as discussed further with respect to FIG. 4, battery packs 108A and/or 108B and/or their internal components (e.g., one or more individual batteries and/or battery cells) may be connected serially, in parallel or a combination thereof to drive the motor, such as motor 114. The batteries, battery cells and/or other types of energy storage components may be standardized energy storage devices (e.g., 12V at 14 Ah) that can be coupled together in a manner to provide other voltages (e.g., 24V, 36V, 48V, or any other suitable amount of voltage). In this regard, the type of energy storage devices used (lead-acid, Lithium, etc.) and/or the power output of the energy storage device(s) may be configured for one or more particular embodiments (taking into consideration, e.g., the size of the motor, size of the motorcycle (smaller motorcycles may require less power), performance desired, etc.). For example, the amount and configuration of the storage components used can be determined by the voltage draw of the motor used. In some embodiments, the higher the voltage, the better. In some smaller motorcycles (such as those smaller than 700 mm), when standard 12V batteries are used, two of may be used to provide power at 24V, three for 36V, etc., and motors can then be used that are configured for 24-60V.

Mounting batteries in some types of electric motorcycles, such as those having a seat height (namely, “H” shown in FIG. 1 extending from the ground to the top of seat 102) up to 700 millimeters, can create various problems due to the robust shape the motorcycle must take to accommodate several batteries. For example, in smaller motorcycles, when a sufficient number of batteries to drive the motor are mounted in this manner, it may not allow the motor to be placed in the frame (as shown in FIGS. 1-3) of the motorcycle because of a lack of space. In such embodiments, the motor can be mounted in the rear fork, such as near where the rear wheel is mounted to the rear fork. Or, some embodiments may have the bottom of frame 104 (and/or any fairing affixed to frame 104) be substantially broader (e.g., more than 4 inches) than the top portion of frame 104 (and/or the fairing affixed to frame 104).

Alternatively, some embodiments may be configured as shown in FIGS. 1-3 to have a more proportionally balanced design with a frame 104 that is approximately (within 0-4 inches) the same width along vertical axis 110H or does not need to be varied due to the placement of the battery packs (even if the width varies for other reasons, such as aesthetics). The embodiments shown in FIGS. 1-3 also include the motor mounted in the frame. By mounting both the batteries and the motor within the frame, increased maneuverability can be provided for relatively smaller motorcycles, such as those with a seat height of 700 millimeters or less. To facilitate such a balanced design, one or more of battery packs 108A and/or 108B can be configured to be rectangular in shape, where the length of one or more of the battery packs (namely the side of the battery extending parallel to longitudinal axis 110L) is longer than the respective battery pack's width and/or height. Such battery packs are sometimes referred to herein as “narrow compact energy storage device.” Further, such an energy storage device can be a box-shape and/or other three-dimension shape having a rectangular base, wherein the length of the base of the one or more of the battery packs 108A and/or 108B is 1.5×, 2.0×, 3.0× and/or any other suitable size that is greater than the width of the corresponding battery pack. (As referred to herein, 1.5× includes a +/−5% margin of error.) In this regard, when battery packs 108A and/or 108B are placed into the frame 104, the shorter side of battery packs 108A and/or 108B (i.e., the width thereof) can be cross-wise to the driving direction and the longer side of battery packs 108A and/or 108B (i.e., the corresponding length of the base). Other proportions of width versus length and/or height may be applicable in other embodiments. Battery packs 108A and/or 108B and/or their internal components (e.g., one or more individual batteries and/or battery cells) can be connected serially, in parallel or a combination thereof, additional examples of which are discussed further below.

As shown in FIGS. 1-3, frame 104 can be configured to have motor and/or one or more battery packs mounted therein using brackets, bolts, screws, welds, and/or any other suitable fastening mechanism. In embodiments consistent with the example shown in FIGS. 1-3, motor 114 can be mounted in the frame in area 116, which can be in proximity to where the rear fork 118 connects or otherwise extends from frame 104. Battery packs 108A and 108B can also be placed around area 116, such that motor 114 and battery packs 108A, 108B collectively occupy one or more relatively small, narrow spaces defined by frame 104. The longest side of battery packs 108A, 108B can be mounted on and within the frame, such that the longest side of both battery packs 108A, 108B is parallel to longitudinal axis 110L of the electric motorcycle 100. Furthermore, battery packs 108A, 108B can be stacked in different internal areas of frame 104, as shown in FIGS. 1-3, such that battery packs 108A, 108B are positioned within frame 104 in multilevel fashion along both longitudinal axis 110L and/or vertical axis 110H of electric motorcycle 100. Additionally or alternatively, as discussed further in connection with FIG. 4, one or more of battery packs 108A, 108B can include a plurality of individual batteries, battery cells, a protective housing, wiring, battery circuitry and/or any other suitable components. The configuration shown in FIGS. 1-3 can be advantageous in providing, for example, maneuverable children's motorcycles.

In some embodiments, frame 104 may be approximately the same width along vertical axis 110H, thereby providing a relatively proportionally-balanced design. In such embodiments, frame 104 may be shaped to provide sufficient space for mounting the motor and the battery packs to frame 104 within a space defined by width 180 along lateral axis 110W of frame 104 (FIG. 3). Here, the width of the mounted motor and mounted battery packs along lateral axis 110W does not exceed width 180 (or at least does not noticeably or substantially exceed width 180) of frame 104 at points along vertical axis 110H. In some embodiments, frame 104 may be a closed frame that is configured for motor 114 to be mounted therein and behind battery pack 108A. As such, motor 114 can be positioned longitudinally with its longest side in the direction perpendicular to longitudinal axis 110L and parallel to lateral axis 110W of the electric motorcycle 100. Battery pack 108B can be positioned above motor 114 relative to the vertical axis 110W.

Additionally or alternatively, motor(s) and/or battery pack(s) can be mounted in the rear fork 118. For example, the motor's longest side can be parallel to the direction of longitudinal axis 110L of the electric motorcycle 100 when positioned in rear fork 118. As another example, one or more battery packs can be located in the backbone frame, or in other types of motorcycle frames.

FIG. 4 shows an example arrangement of battery packs 108A, 108B. While in some embodiments one or more of battery packs 108A, 108B may include only a single battery and/or battery cell, in other embodiments, battery packs 108A, 108B may include one or more individual batteries and/or cells as well as other components, such as battery control circuitry, etc. Battery packs 108A, 108B can include a common housing, which may include plastic, metal, rubber and/or any other component suitable from protecting the components therein from the elements (e.g., sand, water, dust, etc.) expect or unexpected during normal operation of the electric motorcycle 100.

In some embodiments, the overall shape of battery packs 108A, 108B may be longest in one direction, which may then be positioned in frame 104 as discussed above (e.g., each defining battery pack defining an associated length larger than its associated width and associated height). However, within battery packs 108A, 108B, any suitable shaped batteries and/or other components may be included. For example, battery packs 108A, 108B may include two batteries, such as batteries 402 and 404, arranged in any suitable manner. Each of batteries 402 and 404 may include a plurality of battery cells. For example, battery 402 may include three battery cells 404 that are stacked upon each other vertically as shown in FIG. 4. As another example, battery 404 may include a number of cells, namely cells 404A-404N, that are placed next to each other longitudinally. One or more of batteries 402, 404 and/or one or more of the individual battery cells may also have their own respective housing(s). A “battery element,” as used herein, refers to battery packs (including more than one battery connected in parallel or in series) or a single battery. In either case, a battery element may have a characteristic voltage and capacity (measured in amp hours, or Ah). In some embodiments, these battery elements may be electrically coupled together (in series, parallel, combination thereof, and/or by any suitable means) to function as a power source to the motor, such as motor 114 shown in FIGS. 1-3. An “energy storage device,” as referred to herein, is a general phrase that includes batteries, battery elements, battery packs, battery cells, and/or any other suitable energy storage device, including combinations thereof. One or more energy storage devices is sometimes referred to herein as a “power source.”

In some embodiments, the power source may be configured to match the voltage of the motor. For instance, 24-60V motors may be sufficient to power a small motorcycle. Here, a plurality of 12V battery elements may be connected in series to function as a 24V (e.g., two 12V batteries in series), 36V (e.g., three 12V batteries in series) or 48V power source (e.g., four 12V batteries in series) to drive a 24V, 36V or 48V motor, respectively.

In addition, the power source may be connected in parallel to increase the capacity of the power source. For instance, the 12V battery elements discussed above may each have a capacity of 14 Ah. For example, two sets of serially connected battery elements (i.e., each set forming a 24V power source having a capacity of 14 Ah) may be connected in parallel to form a 24V power source having a capacity of 28 Ah. In another example, three sets of such serially connected battery elements may be connected in parallel to form a 24V power source having a capacity of 42 Ah.

In an example where battery packs 108A and/or 108B include a plurality of batteries, the batteries may be arranged in the battery packs in various ways. For instance, four 12V, 14 Ah batteries may drive a 24V motor at a capacity of 28 Ah when two of the batteries are connected in series within each battery pack and the two battery packs connected in parallel. Alternatively or additionally, one of battery packs 108A or 108B may be connected in parallel within the battery pack with the two battery packs connected in series. Put another way, it is contemplated that the number and arrangement of batteries within battery packs 108A and/or 108B may be configured to provide a power source of sufficient voltage to the motor at a desired battery capacity in some embodiments. At the same time, space considerations associated with fitting the battery packs within the frame, as discussed above, may be accommodated without having to move the batteries outside the frame.

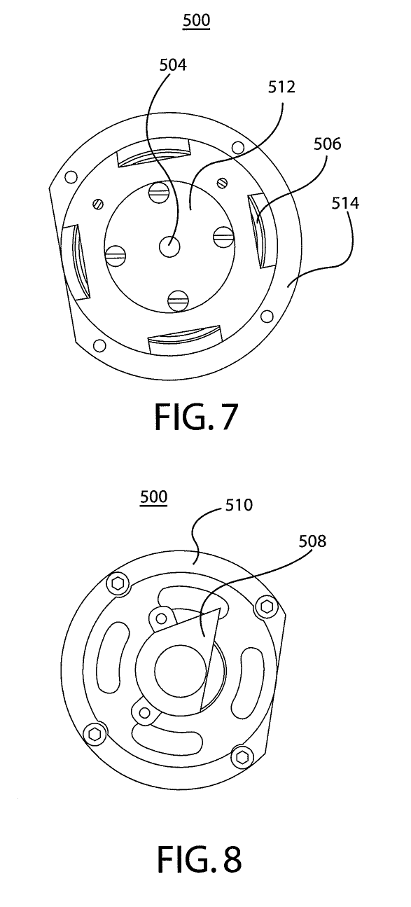

FIGS. 5-8 show an example electric drive 500 in accordance with some embodiments. Although electric drive 500, like other aspects of this disclosure, is discussed in connection with motorcycles, it like other aspects of this disclosure may be used for any suitable purpose, including other types of vehicles, electric-powered toys and/or other machines that may benefit from more performance and relatively lower weight.

While some embodiments of motorcycle 100 can be equipped with a direct current (“DC”) motor, some embodiments may also or instead include an alternating current motor (“AC”), which may be useful in embodiments having lower horsepower. DC motors can provide relatively high torque at low revolutions and do not have to be equipped with a centrifugal clutch or gearbox. In many instances, DC motors can have a rugged design and bigger volume than AC motors and can be used in direct-drive vehicles. Electric drive 500 can be an AC motor having high performance in view of its weight. The AC motors currently used in vehicles are equipped with a gearbox and often provide less torque during acceleration and produce more heat during operation at full or near full load.

Some embodiments of electric drive 500 discussed herein can overcome the disadvantages above by including an AC motor connected to a centrifugal clutch by a shaft, which is placed in a protective, cooling housing unit that is attached to the stator of the AC electric motor by a bracket and/or other suitable means. For example, some embodiments may be configured to lack a transmission (e.g., be “transmissionless”) and have the direct drive of the electric motor be equipped with a centrifugal clutch mounted directly on its axis to a front sprocket, which then is connected to rear sprocket by chain. As such, the motor is connected with rear wheel without the need of transmission.

Also or instead, the cooling housing unit can be connected to the clutch basket on the opposite side of the motor. In some embodiments, cooling housing material can include an aluminum alloy, among other things. By combining an electric drive, such as electric drive 500, with one or more narrow compact storage cell assemblies discussed above, further improvements in maneuverability and space conservation can be realized, which may be especially advantageous in smaller electric motorcycles. For example, electric drive 500 can be one example of motor 114 discussed above.

By including an AC motor coupled to a centrifugal clutch to power vehicles, some embodiments of electric drive 500 can be configured to enable relatively smooth transmission of torque and a smaller load current with zero or close to zero stored power consumption when moving on its own inertia, thereby extending the lifetime of the battery relatively to embodiments where the battery power is drained even while the motorcycle is moving on its own inertia (e.g., without the user applying power via the throttle). The cooling housing can include and be constructed from relatively well-conductive material, which can assist in preventing the motor from getting too hot during operation. According to some embodiments, the AC electric motor can be structurally simpler and lighter than previously used drives with these motors.

Turning now to the example of FIGS. 5-8, a centrifugal clutch, such as clutch 502, can be fixed inside the clutch basket 510 and positioned on shaft 504 of AC motor 506. Shaft carrier 508 of the clutch drum can be mounted on the clutch basket 510. The clutch drum shaft can have a toothed wheel (not shown), which can be coupled to the rear wheel with a chain link and/or any other suitable means. The stator of AC motor 506 can be equipped with a bracket 512 at the end, which can be connected to the protective cooling housing unit 514. Protective cooling housing unit 514 can comprise an aluminum alloy and/or any other suitable materials that may aid in, for example, removing the heat generated during the operation of the alternating current electric motor 506, protecting motor 506 against the ingress of dirt into the rotor during vehicle operation, etc. On the opposite side the stator of AC 506 can be a cover 516 for the windings of the rotor of motor 506, which may be in the shape of a flange and/or otherwise be configured to prevent dirt from the centrifugal clutch entering into the rotor of motor 506. The protective cooling housing unit 514 can be connected to the clutch basket 510 on the opposite side. In some embodiments, protective cooling housing unit 514 can include one or more (e.g., four) ventilation holes and be linked from the side to the centrifugal clutch by the clutch basket.

As such, discussed herein are embodiments that may enable children's sports electric motorcycles to be more practical by avoiding excess weight and increasing performance and stability without causing the bottom portion of the motorcycle to be very wide, which could restrict smaller drivers when maneuvering. Further embodiments discussed herein can provide electric motorcycles for children that have the same and/or similar benefits (including a proportionally, aesthetically pleasing design) as adult motorcycles with cross-placed batteries, without the batteries actually being cross-placed in the child's motorcycle (which have more space constraints). Additionally, some embodiments allow for the batteries to be placed in the smaller motorcycle's frame without the electric engine needing to be placed (though it could be placed) on the rear fork, thereby enabling proportions of smaller motorcycles to be the same as or substantially similar to motorcycles designed for adults, by using the longitudinal dimension of the frame for motorcycle power source.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

1. A motorcycle frame comprising:
an electric drive assembly comprising an alternating current electric motor and centrifugal clutch, wherein the electric drive is mounted directly on its axis to a front sprocket, which then is connected to a rear sprocket by a chain such that the motorcycle frame is transmissionless; and
at least one narrow energy storage device configured to store power used by the electric drive assembly, wherein the motorcycle frame is configured to accommodate an electric motorcycle that has a seat top 700 millimeters or less from where the electric motorcycle's rear wheel touches the ground.

2. The motorcycle frame of claim 1, wherein the electric drive assembly further comprises:
a shaft connected to the electric motor;
a stator; and
a housing unit configured to enclose and provide protection and cooling to the alternating electric motor and the centrifugal clutch, wherein the housing is attached to the stator by a bracket.

3. The motorcycle frame of claim 2, wherein the housing unit is configured to connect to the centrifugal clutch opposite the positioning of the alternating current electric motor within the housing unit.

4. The motorcycle frame of claim 2, wherein the housing unit is configured to protect the alternating current electric motor and aid in dissipating heat generated by the alternating current electric motor during operation.

5. The motorcycle frame of claim 1, wherein the at least one narrow energy storage device includes a plurality of batteries.

6. The motorcycle of claim 5, wherein the plurality of batteries are electrically coupled together.

7. The motorcycle of claim 5, wherein the at least one narrow energy storage device includes a housing that encloses the plurality of batteries.

8. The motorcycle of claim 1, wherein the at least one narrow energy storage device includes a plurality of battery cells.

9. A motorcycle comprising:
a frame configured to mount to a front wheel and a rear wheel, the frame defining a longitudinal axis, a vertical axis and a lateral axis, wherein:
the longitudinal axis extends in a direction from the front wheel to the rear wheel when mounted,
the vertical axis extends in the direction of gravity, and
the lateral axis extends orthogonal to a plane defined by the longitudinal axis and the vertical axis;
an electric motor configured to be mounted in the frame; and
a battery pack configured to be mounted in the frame, wherein the battery pack defines a length, a width and a height, wherein the length is larger than both the width and the height, the length extending in a direction parallel to the longitudinal axis of the frame when mounted in the frame.

10. The motorcycle of claim 9, wherein the at least one battery pack includes a plurality of batteries.

11. The motorcycle of claim 10, wherein the plurality of batteries are electrically coupled together.

12. The motorcycle of claim 10, wherein the at least one battery pack includes a housing that encloses the plurality of batteries.

13. The motorcycle of claim 10, wherein the plurality of batteries each include a respective battery housing.

14. The motorcycle of claim 9, wherein the at least one battery pack includes a plurality of battery cells.

15. The motorcycle of claim 9 further comprising a plurality of battery packs, each defining an associated length larger than an associated width and associated height of each of the battery packs.

16. The motorcycle of claim 15, wherein the battery packs are stacked to form layers along the longitudinal axis of the motorcycle.

17. The motorcycle of claim 9, wherein the frame is configured to have the motor mounted in proximity to where a rear fork extends for mounting the rear wheel.

18. The motorcycle of claim 9 further comprising a seat mounted to the frame, wherein the seat defines a top on which a user sits and the top of the seat is 700 millimeters or less from where the rear wheel touches the ground when the rear wheel is mounted to the frame.

19. An electric motor assembly comprising:
an alternating current electric motor;
a shaft connected to the electric motor;
a centrifugal clutch;
a stator; and
a housing unit configured to enclose and provide protection and cooling to the alternating electric motor and the centrifugal clutch, wherein the housing is attached to the stator by a bracket.

20. The electric motor assembly comprising of claim 19, wherein the housing unit is configured to connect to the centrifugal clutch opposite the positioning of the alternating current electric motor within the housing unit.

21. The electric motor assembly comprising of claim 19, wherein the housing unit is configured to protect the alternating current electric motor and aid in dissipating heat generated by the alternating current electric motor during operation.

22. The electric motor assembly comprising of claim 19, wherein the housing unit comprises an aluminum alloy.
